(19) United States
(12) Patent Application Publication
(10) Pub. No.: US 2026/0045410 A1
(43) Pub. Date: Feb. 12, 2026

(54) HALIDE, DIELECTRIC MATERIAL, CAPACITOR, ELECTRIC CIRCUIT, CIRCUIT BOARD, AND DEVICE

(71) Applicant: Panasonic Intellectual Property Management Co., Ltd., Osaka (JP)

(72) Inventors: TOMOYASU YOKOYAMA, Osaka (JP); RYOSUKE KIKUCHI, Osaka (JP)

(21) Appl. No.: 19/363,741

(22) Filed: Oct. 21, 2025

Related U.S. Application Data
(63) Continuation of application No. PCT/JP2024/014332, filed on Apr. 9, 2024.

(30) Foreign Application Priority Data
May 12, 2023 (JP) 2023-079636

(51) Int. Cl. H01G 4/08; H01G 2/06

(52) U.S. Cl. CPC H01G 4/08; H01G 2/065

(57) ABSTRACT

A halide includes a crystal having a composition represented by ASn₂X₅. In the composition, A is a molecular cation containing at least one nitrogen atom and X is a halogen element.

### BACKGROUND

### 1. Technical Field

The present disclosure relates to a halide, a dielectric material, a capacitor, an electric circuit, a circuit board, and a device.

### 2. Description of the Related Art

Halides are conventionally used in devices such as perovskite solar cells.

Japanese Unexamined Patent Application Publication No. 2016-171152, for example, describes a ferroelectric memory element including a pair of electrodes, and a ferroelectric layer sandwiched between the electrodes. The ferroelectric layer comprises a particular halide-based organic-inorganic hybrid perovskite compound or a particular halide-based inorganic perovskite compound. CH₃NH₃PbI₃, C₂H₅NH₃PbI₄, CH₃NH₃SnI₃, C₂H₅NH₃SnI₄, etc. are described in the patent document as examples of the halide-based organic-inorganic hybrid perovskite compound, and CsSnI₃, etc. are described as examples of the halide-based inorganic perovskite compound.

### SUMMARY

In one general aspect, the techniques disclosed here feature a halide comprising a crystal having a composition represented by ASn₂X₅, where A is a molecular cation containing at least one nitrogen atom and X is a halogen element.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a diagram showing the crystal structure of CsSn₂Cl₅;

FIG. 1B is a diagram showing the crystal structure of (NH₄)Sn₂Cl₅;

FIG. 2A is a graph showing the electronic density of states of CsPb₂Cl₅ obtained by first-principles calculations;

FIG. 2B is a graph showing the electronic density of states of (NH₄)Pb₂Cl₅ obtained by first-principles calculations;

FIG. 2C is a graph showing the electronic density of states of CsSn₂Cl₅ obtained by first-principles calculations;

FIG. 2D is a graph showing the electronic density of states of (NH₄)Sn₂Cl₅ obtained by first-principles calculations;

FIG. 3A is a diagram showing the crystal structure of CsSnCl₃;

FIG. 3B is a diagram showing the crystal structure of CsSnCl₃;

FIG. 4A is a diagram showing the crystal structure of CsSn₂Cl₅;

FIG. 4B is a diagram showing the crystal structure of CsSn₂Cl₅;

FIG. 4C is a diagram showing the crystal structure of CsSn₂Cl₅;

FIG. 5A is a cross-sectional view showing an example of a capacitor of the present disclosure;

FIG. 5B is a cross-sectional view showing another example of a capacitor of the present disclosure;

FIG. 5C is a cross-sectional view showing yet another example of a capacitor of the present disclosure;

FIG. 5D is a cross-sectional view showing yet another example of a capacitor of the present disclosure;

FIG. 6A is a diagram schematically showing an example of an electric circuit of the present disclosure;

FIG. 6B is a diagram schematically showing an example of a circuit board of the present disclosure;

FIG. 6C is a diagram schematically showing an example of a device of the present disclosure;

FIG. 7 is a diagram schematically showing a method for evaluating the relative dielectric constants of the halides of Examples and Comparative Examples;

FIG. 8 is a graph showing the XRD pattern of the halide of Example 1;

FIG. 9 is a graph showing the XRD pattern of the halide of Example 2; and

FIG. 10 is a graph showing the XRD pattern of the halide of Example 3.

### DETAILED DESCRIPTIONS

### Findings Underlying the Present Disclosure

In recent years, as electronic devices have become smaller and more sophisticated, electronic circuits have become smaller and more highly integrated, and have come to operate at higher frequencies. Therefore, downsizing and improvements in performance are required for electronic components for use in electronic circuits. For example, if a small capacitor having a high capacitance can be provided, it will contribute to the downsizing and improvements in performance of electronic components. The capacitance of a capacitor depends on the relative dielectric constant of a dielectric used in the capacitor; the higher the relative dielectric constant, the higher the capacitance. Capacitors using an oxide dielectric, which exhibits a high relative dielectric constant, have been widely developed. However, the synthesis of such an oxide often requires a heat treatment at a temperature as high as 500° C. or more, resulting in a high manufacturing cost of a capacitor. Further, an oxide often has a small elastic constant, which makes it difficult to increase the filling rate of a pressed powder product. Therefore, it is difficult to enhance the performance of a capacitor. In addition, an oxide is unlikely to have high strength against bending stress.

A halide has the potential to eliminate the disadvantages of such an oxide. A halide is generally highly soluble in water and an organic solvent, and therefore can be easily synthesized by a coating method. In addition, a halide can be synthesized at a temperature as low as 200° C. or less. Therefore, a reduction in the manufacturing cost of a capacitor can be expected. Further, a halide film can be formed even on a substrate like a film whose high-temperature endurance is not high. Therefore, the realization of a flexible capacitor can be expected. Furthermore, a halide generally has a higher elastic constant than an oxide, making it possible to increase the filling rate of a pressed powder product. However, the relative dielectric constant of a halide is low at room temperature. This may lead to no expectation of a high capacitance as achieved by the use of an oxide dielectric.

In view of such a situation, the present inventors have intensively studied whether it is possible to increase the relative dielectric constant of a halide by allowing a molecular ion to exist as part of a cation in the halide. As a result, the inventors have newly found that a halide, containing a particular molecular cation and tin, is likely to have a high relative dielectric constant. Based on this finding, the inventors have devised a halide of the present disclosure.

According to the present disclosure, it is possible to provide a halide which is advantageous in terms of high relative dielectric constant.

### EMBODIMENTS

Embodiments of the present disclosure will now be described with reference to the drawings. The present disclosure is not limited to the following embodiments.

The halide of the present disclosure comprises a crystal having the composition ASn₂X₅. In the composition, A is a molecular cation containing at least one nitrogen atom. The molecular cation may contain two or more nitrogen atoms. X is a halogen element. The molecular ion contained in the halide is polarizable. The energy state of the lone pair in Sn²⁺ is high; Sn²⁺ has an unstable electronic state. Therefore, compared to Pb²⁺ which has a stable electronic state, Sn²⁺ is more susceptible to the polarization of the molecular ion, and the halide is more likely to have a high relative dielectric constant.

The cation, represented by A in the above composition, may have only one or more nitrogen atoms and one or more hydrogen atoms, or may further contain one or more carbon atoms.

The cation, represented by A in the above composition, is, for example, an ammonium ion represented by the following formula (I). In formula (I), R¹, R², R³, and R⁴ are each independently a hydrogen atom, an alkyl group, an aryl group, or NH₂. In this case, the molecular cation is likely to have the desired polarization, and the halide is more likely to have a high relative dielectric constant.

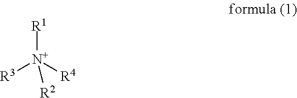

In formula (I), R¹ and R² may each independently be a hydrogen atom, an alkyl group, or an aryl group, and R³ and R⁴ may each be a hydrogen atom. In this case, the molecular cation is likely to have the desired polarization, and the halide is more likely to have a high relative dielectric constant.

In formula (I), R¹, R², R³, and R⁴ may each be a hydrogen atom. In this case, the molecular cation is likely to have the desired polarization, and the halide is more likely to have a high relative dielectric constant.

In formula (I), R¹, for example, may be NH₂, and R², R³, and R⁴ may each be a hydrogen atom. In this case, the molecular cation is likely to have the desired polarization, and the halide is more likely to have a high relative dielectric constant.

When the cation, represented by A in the above composition, is an ammonium ion represented by the above formula (I), and R¹, R², R³, or R⁴ is an alkyl group, the alkyl group is not particularly limited. The number of carbon atoms in the alkyl group is, for example, 1 to 20. At least one hydrogen atom in the alkyl group may be substituted or unsubstituted. For example, [Guo-Ping Li, Si-Qi Lu, Xin Chen, Wei-Qiang Liao, Yuan-Yuan Tang, and Ren-Gen Xiong, “A Three-Dimensional M₃AB-Type Hybrid Organic-Inorganic Antiperovskite Ferroelectric: [C₃H₇FN]₃[SnCl₆]Cl”, Chem. Eur. J. 2019, 25, 16625-16629] describes an anti-perovskite structure in which the cation contains an alkyl group. It will therefore be understood that the halide of the present disclosure can contain an alkyl group-containing cation as the cation A.

The alkyl group may be a saturated radical having a straight or branched chain. At least one hydrogen atom in the saturated radical may be substituted or unsubstituted. The alkyl group is, for example, a saturated hydrocarbon radical having 1 to 20 carbon atoms and having a straight or branched chain. At least one hydrogen atom in the saturated hydrocarbon radical may be substituted or unsubstituted. The alkyl group may be an alkyl group having 1 to 20 carbon atoms. Examples of such an alkyl group include a methyl group, an ethyl group, a propyl group, a butyl group, a pentyl group, a hexyl group, a heptyl group, an octyl group, a nonyl group, and a decyl group. The alkyl group may be an alkyl group having 1 to 6 carbon atoms. Examples of such an alkyl group include a methyl group, an ethyl group, a propyl group, a butyl group, a pentyl group, and a hexyl group. The alkyl group may be an alkyl group having 1 to 4 carbon atoms. Examples of such an alkyl group include a methyl group, an ethyl group, an i-propyl group, an n-propyl group, a t-butyl group, an s-butyl group, an n-butyl group, and a pentyl group.

When at least one hydrogen atom in the alkyl group is substituted by a substituent, the substituent may include, for example, one or more substituents selected from the group consisting of an alkyl group, an aryl group, a cyano group, and an amino group. The alkyl group as the substituent may have 1 to 20 carbon atoms. At least one hydrogen atom in the alkyl group as the substituent may be substituted or unsubstituted. At least one hydrogen atom in the aryl group may be substituted or unsubstituted. Examples of the substituent include an alkylamino group, a dialkylamino group, an arylamino group, a diarylamino group, an arylalkylamino group, an amido group, an acylamido group, a hydroxy group, an oxo group, a halo group, a carboxy group, an ester group, an acyl group, an acyloxy group, an alkoxy group, an aryloxy group, a haloalkyl group, a sulfonic acid group, a sulfhydryl group, an alkylthio group, an arylthio group, a sulfonyl group, a phosphoric acid group, a phosphoric acid ester group, a phosphonic acid group, and a phosphonic acid ester group. Examples of substituted alkyl groups include a haloalkyl group, a hydroxyalkyl group, an aminoalkyl group, an alkoxyalkyl group, and an alkaryl group. The alkaryl group is, for example, an alkyl group having 1 to 20 carbon atoms, in which at least one hydrogen atom is substituted by an aryl group. The alkaryl group is not particularly limited. Examples of the alkaryl group include a benzyl group, a benzhydryl group, a trityl group, a phenethyl group, a styryl group, and a cinnamyl group.

When the cation, represented by A in the above composition, is an ammonium ion represented by the above formula (I), and R¹, R², R³, or R⁴ is an aryl group, the aryl group is not particularly limited. The aryl group is, for example, a monocyclic or bicyclic aromatic group. The aryl group has, for example, a ring structure containing 6 to 14 carbon atoms, preferably a ring structure containing 6 to 10 carbon atoms. At least one hydrogen atom in the aryl group may be substituted or unsubstituted. Examples of the aryl group include a phenyl group, a naphthyl group, an indenyl group, and an indanyl group. When the aryl group is substituted, the aryl group has, for example, one or more substituents selected from the group consisting of an unsubstituted alkyl group having 1 to 6 carbon atoms, an unsubstituted aryl group, a cyano group, an amino group, an alkylamino group, a dialkylamino group having 1 to 10 carbon atoms, an arylamino group, a diarylamino group, an arylalkylamino group, an amido group, an acylamido group, a hydroxy group, a halo group, a carboxy group, an ester group, an acyl group, an acyloxy group, an alkoxy group having 1 to 20 carbon atoms, an aryloxy group, a haloalkyl group, a sulfhydryl group, an alkylthio group having 1 to 10 carbon atoms, an arylthio group, a sulfonic acid group, a phosphoric acid group, a phosphoric acid ester group, a phosphonic acid group, a phosphonic acid ester group, and a sulfonyl group. The aryl group may have no substituent, or may have one, two, or three substituents. The substituted aryl group may be substituted at the 2-position with a single alkylene group having 1 to 6 carbon atoms or with a bidentate group represented by —X—R⁹— or —X—R⁹—X—. R⁹ is an alkylene group having 1 to 6 carbon atoms. X is selected from the group consisting of O, S, and NR¹⁰. R¹⁰ is a hydrogen atom, an aryl group, or an alkyl group having 1 to 6 carbon atoms. The substituted aryl group may be an aryl group fused to a cycloalkyl group or an aryl group fused to a heterocyclyl group. The ring atoms of the aryl group may include one or more heteroatoms as in a heteroaryl group. Such a heteroaryl group is a substituted or unsubstituted monocyclic or bicyclic heteroaromatic group containing 6 to 10 atoms in the ring moiety containing one or more heteroatoms. For example, the heteroaryl group is in the form of a five- or six-membered ring and contains at least one heteroatom selected from O, S, N, P, Se, and Si. The heteroaryl group may contain, for example, 1, 2, or 3 heteroatoms. Examples of the heteroaryl group include a pyridyl group, a pyrazinyl group, a pyrimidinyl group, a pyridazinyl group, a furanyl group, a thienyl group, a pyrazolidinyl group, a pyrrolyl group, an oxazolyl group, an oxadiazolyl group, an isoxazolyl group, a thiadiazolyl group, a thiazolyl group, an isothiazolyl group, an imidazolyl group, a pyrazolyl group, a quinolyl group, and an isoquinolyl group. The heteroaryl group may be unsubstituted, or substituted, for example, in the manner described above with reference to the aryl group. The heteroaryl group may have 0, 1, 2, or 3 substituents.

In formula (I), R¹, R², R³, and R⁴ are each independently, for example, a hydrogen atom, NH₂, a methyl group, or an ethyl group. R¹, R², R³, and R⁴ may each independently be a hydrogen atom, NH₂, or a methyl group.

A tin ion in the halide may have a lone pair. A lone pair is an electron pair composed of two electrons belonging to a particular atom, which have entered an electron orbital in a pair and which are not shared with another atom. For example, an Sn²⁺ ion has a lone pair. In an Sn²⁺ ion, two electrons have been stripped off Sn, and two electrons that fill the outermost s orbital constitute a lone pair. Electrons constituting a lone pair are unlikely to bind with surrounding ions, and may cause an unstable electronic state or a special crystal structure. Accordingly, when the tin ion in the halide has a lone pair, the relative dielectric constant of the halide is likely to be high. In addition to the Sn²⁺ ion, an Sn⁴⁺ ion can also exist as a tin ion. In an Sn⁴⁺ ion, four electrons have been stripped off Sn, and the outermost s orbital is empty. Thus, an Sn⁴⁺ ion does not have a lone pair. In this case, a crystal structure with a low coordination number is likely to be formed, and the relative dielectric constant of the material is unlikely to be high.

For example, all the tin ions in the halide may have a lone pair, or only some of the tin ions in the halide may have a lone pair.

The tin ions in the halide exist, for example, as Sn²⁺ ions. In this case, an Sn²⁺ ion, in which the energy level of the lone pair of the metal cation is high, i.e., which has an unstable electronic state, is considered to be more susceptible to the polarization of the molecular cation A. On the other hand, a Pb²⁺ ion, which has a lower energy level than an Sn²⁺ ion, i.e., has a more stable electronic state, is considered to be less susceptible to the polarization of the cation A.

The X in the halide comprises, for example, at least one selected from the group consisting of F, Cl, Br, and I. In this case, the halide is more likely to have a high relative dielectric constant.

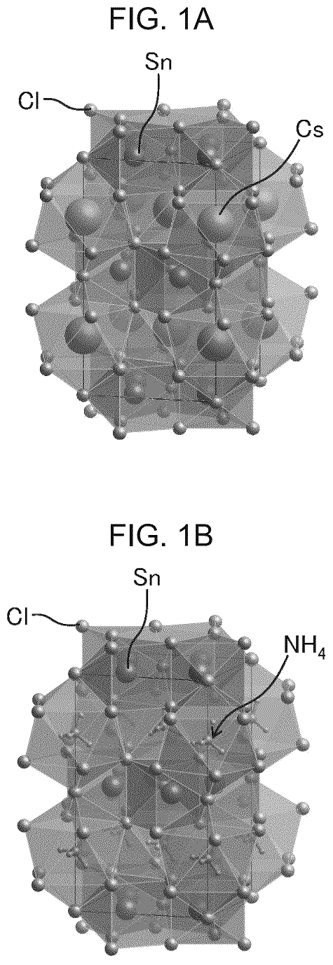

FIG. 1A is a diagram showing the crystal structure of CsSn₂Cl₅. FIG. 1B is a diagram showing the crystal structure of (NH₄)Sn₂Cl₅.

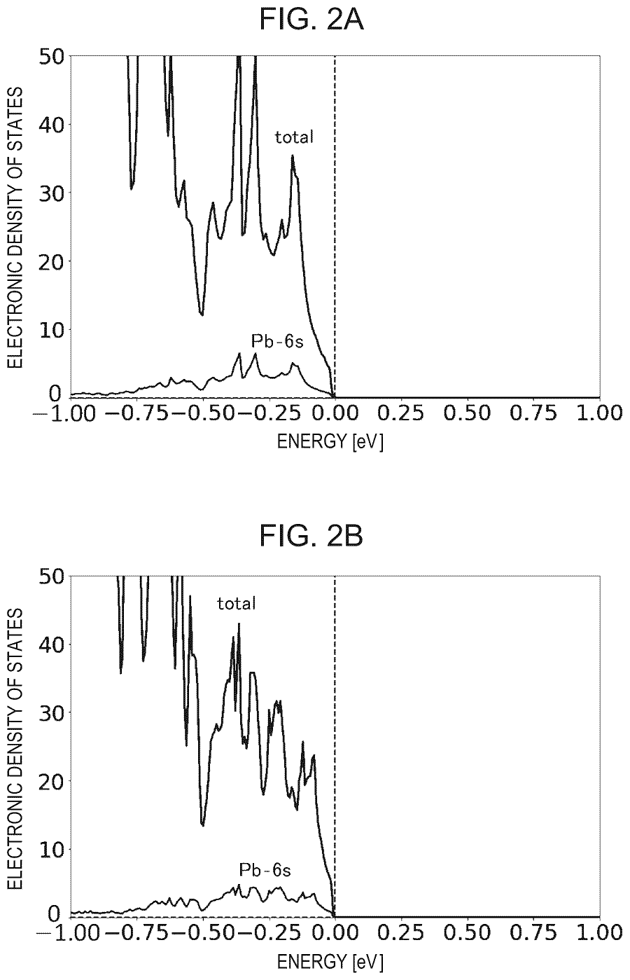

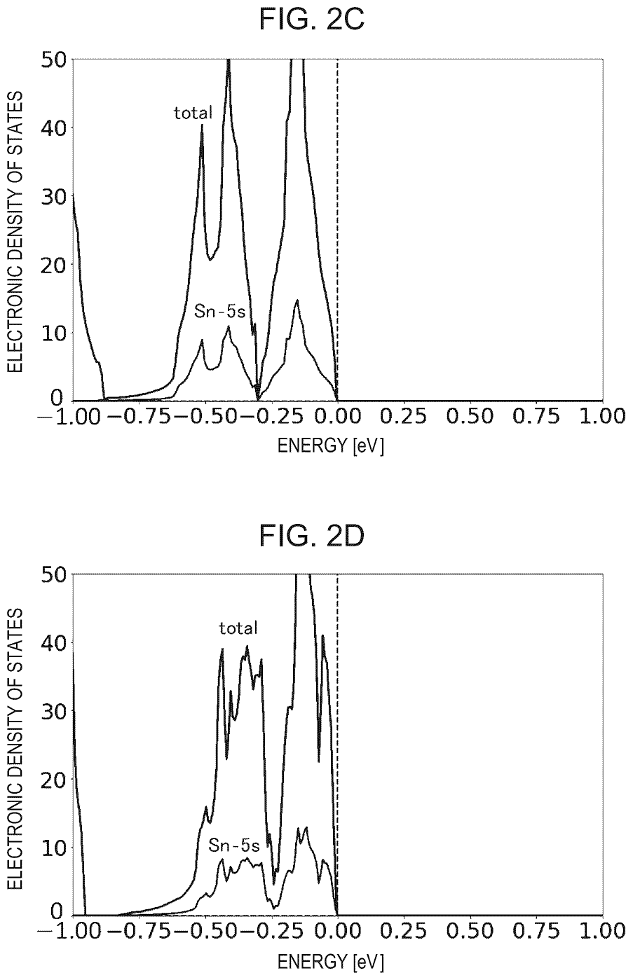

FIG. 2A is a graph showing the electronic density of states of CsPb₂Cl₅ obtained by first-principles calculations. FIG. 2B is a graph showing the electronic density of states of (NH₄)Pb₂Cl₅ obtained by first-principles calculations. FIG. 2C is a graph showing the electronic density of states of CsSn₂Cl₅ obtained by first-principles calculations. FIG. 2D is a graph showing the electronic density of states of (NH₄)Sn₂Cl₅ obtained by first-principles calculations. In these graphs, the ordinate axis represents the electronic density of states, and the abscissa axis represents energy. As shown in FIGS. 2A and 2B, in the case of the compounds containing Pb²⁺ ions, almost no change is observed in the Pb-6s orbital by the replacement of Cs⁺ ions with NH₄⁺ ions. On the other hand, as shown in FIGS. 2C and 2D, in the case of the compounds containing Sn²⁺ ions, the energy of the Sn-5s orbital, existing at the top of the valence band, increases by the replacement of Cs⁺ ions with NH₄⁺ ions, indicating a more unstable electronic state. Therefore, compounds having the composition ASn₂X₅, such as (NH₄)Sn₂Cl₅, are likely to have a high relative dielectric constant. This may be due to the fact that when the molecule is ionized, charges are distributed in a biased manner as compared to the atom, causing polarization, and that since the energy level of the Sn-5s orbital is higher than the energy level of the Pb-6s orbital, Sn²⁺ is strongly influenced by polarization, and thus the distribution of unpaired electrons in the Sn-5s orbital is likely to be biased. It is therefore conceivable that when a cation containing an alkyl group, which is considered to have a higher polarization than NH₄⁺ ion, is used, the compound will likely have a higher relative dielectric constant.

The halide has, for example, an anti-perovskite structure. The halide having such a structure is more likely to have a high relative dielectric constant.

An anti-perovskite structure is a structure in which the positions of a cation and an anion in a normal perovskite compound are interchanged. In other words, the positive or negative of the charges of an ion occupying a particular site in a perovskite compound is opposite to the positive or negative of the charges of an ion occupying the particular site in a compound having an anti-perovskite structure.

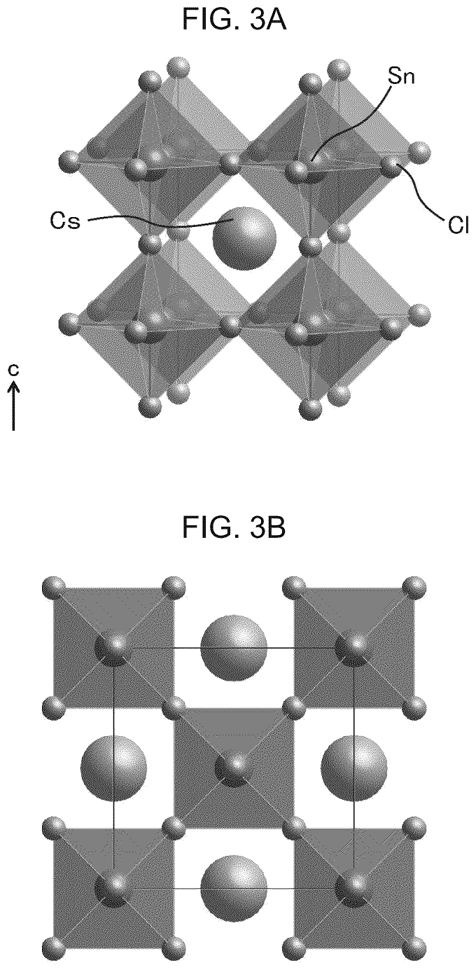

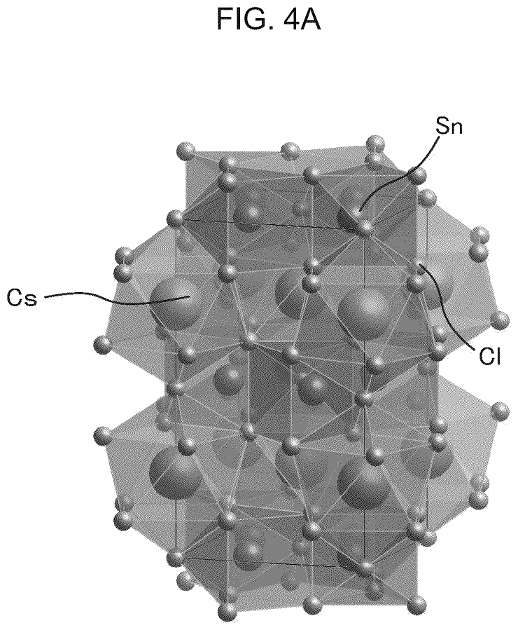

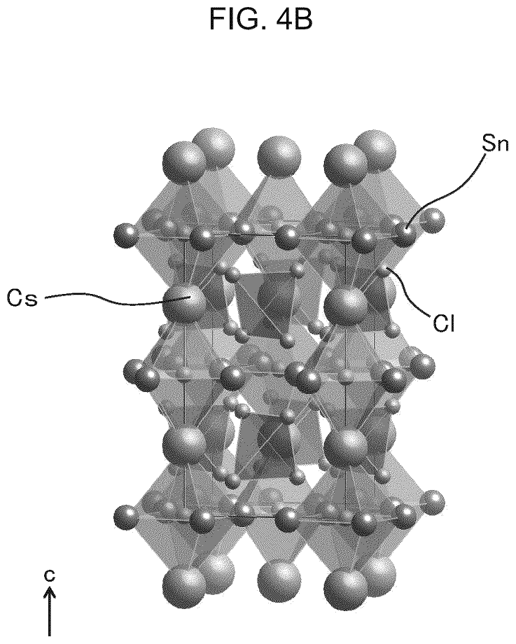

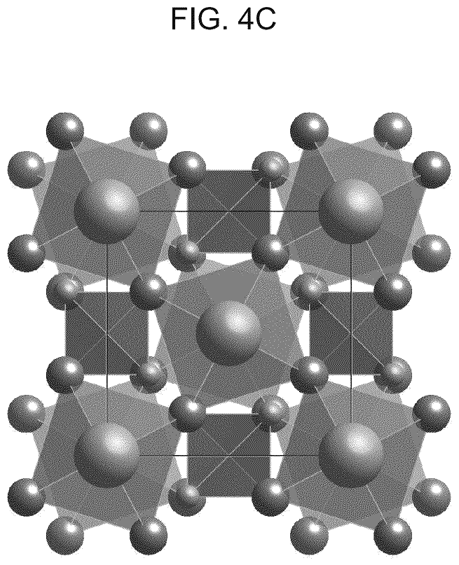

FIGS. 3A and 3B are diagrams showing the crystal structure of CsSnCl₃. FIG. 3B is a diagram showing the crystal structure of FIG. 3A as viewed along a negative direction of a c-axis. CsSnCl₃ has a perovskite structure. FIGS. 4A, 4B, and 4C are diagrams showing the crystal structure of CsSn₂Cl₅. FIG. 4B is a diagram showing the crystal structure of CsSn₂Cl₅ in terms of anion-centered coordination polyhedra. FIG. 4C is a diagram showing the crystal structure of FIG. 4B as viewed along the negative direction of the c-axis. CsSn₂Cl₅ has an anti-perovskite structure. As shown in FIG. 3A, in CsSnCl₃, Cs is located at the A-site of the perovskite structure, Sn is located at the B-site, and Cl is located at the X-site. On the other hand, as shown in FIG. 4B, in CsSn₂Cl₅, Cl₄ are located at a site corresponding to the A-site of the perovskite structure, Cl is located at a site corresponding to the B-site, and Cs or Sn is located at a site corresponding to the X-site. In other words, CsSn₂Cl₅ is expressed as (Cl₄)Cl(CsSn₂) in the notation ABX₃. The relative dielectric constant of CsSnCl₃ was calculated to be 39.4, and the relative dielectric constant of CsSn₂Cl₅ was calculated to be 79.5 by first-principles calculations.

When the halide having the composition ASn₂X₅ has an anti-perovskite structure, for example in the crystal structure shown in FIG. 4B, Cs is replaced with the molecular cation A. In the anti-perovskite structure shown in FIG. 4B, there is a moiety where cations are located at the vertices of octahedrons that share the vertices, and an anion is located at the center of each octahedron. Therefore, ions are likely to line up in a straight line in the anti-perovskite structure, resulting in high polarization. Thus, the halide is more likely to have a high relative dielectric constant.

The anti-perovskite structure of the halide having the composition ASn₂X₅ may be an NH₄Pb₂Br₅-type structure, a Cs₃CoCl₅-type structure, an La₂CuSbS₅-type structure, an La₄FeSb₂S₁₀-type structure, a Ba₄In₂Te₂S₅-type structure, a Y₂HfS₅-type structure, or a TlPb₂Cl₅-type structure.

The relative dielectric constant of the halide is not limited to a particular value. The relative dielectric constant of the halide at room temperature may be, for example, higher than 52 at 1 MHz, or higher than or equal to 55, higher than or equal to 60, higher than or equal to 64, higher than or equal to 70, higher than or equal to 80, higher than or equal to 90, or higher than or equal to 100. The room temperature is, for example, a particular temperature in the range of 20° C. to 25° C. The relative dielectric constant of the halide at room temperature is, for example, lower than or equal to 10,000 at 1 MHz. In other words, the relative dielectric constant of the halide at room temperature is, for example, higher than 52 and lower than or equal to 10,000 at 1 MHz.

A dielectric material can be provided which comprises the above-described halide having the composition ASn₂X₅.

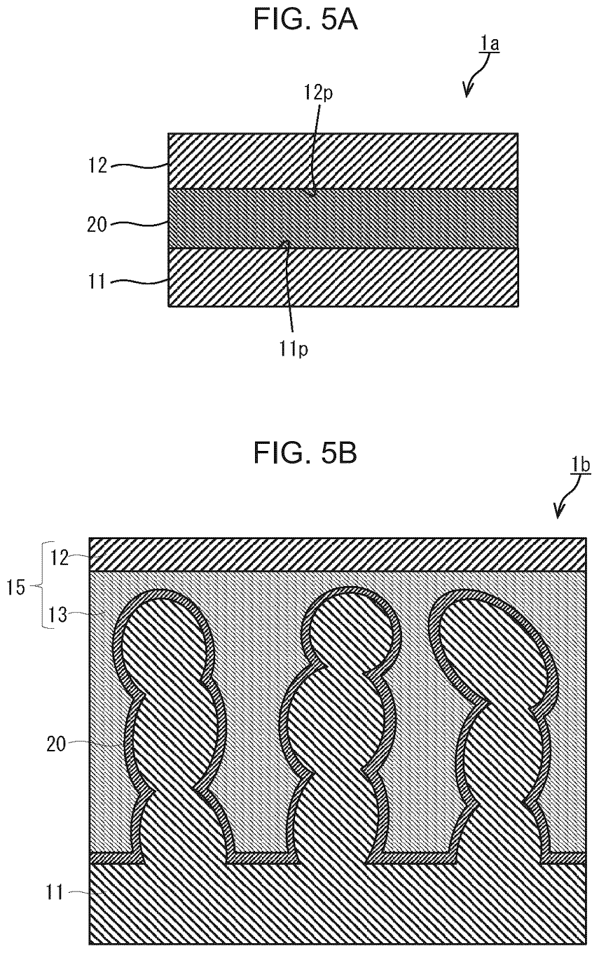

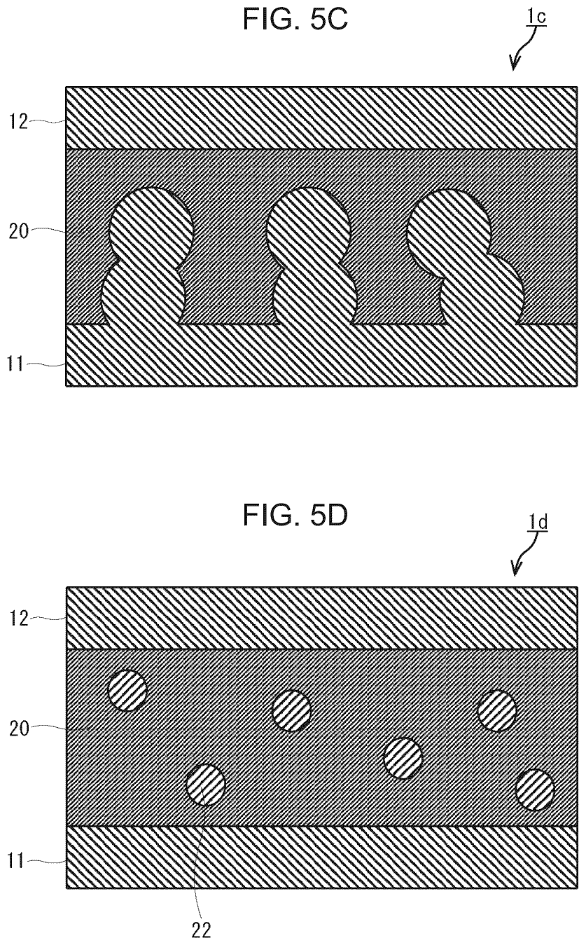

FIG. 5A is a cross-sectional view showing an example of a capacitor of the present disclosure. As shown in FIG. 5A, the capacitor 1a includes a first electrode 11, a second electrode 12, and a dielectric 20 disposed between the first electrode 11 and the second electrode 12. The dielectric 20 comprises the above-described halide having the composition ASn₂X₅. The halide is more likely to have a high relative dielectric constant, and the capacitor 1a is likely to have a high capacitance.

In the capacitor 1a, the dielectric 20 is formed, for example, in the form of a film. There is no particular limitation on the method for forming the dielectric 20. The dielectric 20 may be formed, for example, by spin coating, inkjet printing, die coating, roll coating, bar coating, the Langmuir-Blodgett method, dip coating, or spray coating. The dielectric 20, formed by such a method, is more likely to have a high relative dielectric constant, and the capacitor 1a is more likely to have a high capacitance. The dielectric 20 may also be formed by sputtering, anodization, vacuum deposition, pulsed laser deposition (PLD), atomic layer deposition (ALD), or chemical vapor deposition (CVD).

As shown in FIG. 5A, the dielectric 20 is disposed, for example, between the first electrode 11 and the second electrode 12 in the thickness direction of the dielectric 20. The second electrode 12 covers, for example, at least part of the dielectric 20.

The material of the first electrode 11 and the material of the second electrode 12 are not particularly limited. The first electrode 11 and the second electrode 12 each comprise, for example, a metal. The first electrode 11 comprises, for example, a valve metal. Examples of the valve metal include Al, Ta, Nb, Pb, Sn, and Bi. The first electrode 11 comprises, for example, at least one valve metal selected from the group consisting of Ta, Nb, Pb, Sn, and Bi. The first electrode 11 may comprise a noble metal such as gold or platinum, may comprise nickel, or may comprise a metal element of Group 13, Group 14, or Group 15.

The second electrode 12 may comprise, for example, a valve metal such as Al, Ta, Nb, Pb, Sn, or Bi, may comprise a noble metal such as gold, silver, or platinum, may comprise nickel, or may comprise a metal element of Group 13, Group 14, or Group 15. The second electrode 12 comprises, for example, at least one selected from the group consisting of Al, Ta, Nb, Bi, gold, silver, platinum, and nickel.

As shown in FIG. 5A, the first electrode 11 has a principal surface 11p. One principal surface of the dielectric 20 is, for example, in contact with the principal surface 11p. The second electrode 12 has a principal surface 12p parallel to the principal surface 11p. The other principal surface of the dielectric 20 is, for example, in contact with the principal surface 12p.

FIG. 5B is a cross-sectional view showing another example of a capacitor of the present disclosure. The capacitor 1b shown in FIG. 5B is configured similarly to the capacitor 1a except for a feature which will be particularly described. The same symbols are used for elements or components of the capacitor 1b which are the same as or equivalent to those of the capacitor 1a, and a detailed description thereof will be omitted. The above description of the capacitor 1a applies also to the capacitor 1b as long as there is no technical contradiction. The same holds true for the below-described capacitors 1c and 1d.

The capacitor 1b shown in FIG. 5B is an electrolytic capacitor. As shown in FIG. 5B, in the capacitor 1b, at least part of the first electrode 11 is porous. With such a feature, the first electrode 11 is likely to have a large surface area, and the capacitor 1b is likely to have a higher capacitance. Such a porous structure can be formed by a method such as etching of a metal foil or sintering of a powder.

As shown in FIG. 5B, a film of dielectric 20 is formed, for example, over the surface of the porous portion of the first electrode 11. Examples of usable methods for forming the dielectric 20 include spin coating, inkjet printing, die coating, roll coating, bar coating, the Langmuir-Blodgett method, dip coating, and spray coating. The dielectric 20 may also be formed, for example, by sputtering, anodization, vacuum deposition, PLD, ALD, or CVD.

The first electrode 11 comprises, for example, a valve metal such as Al, Ta, Nb, Zr, Hf, Pb, Sn, or Bi. The second electrode 12 may comprise, for example, a solidified silver-containing paste or a carbon material such as graphite, or both the solidified paste and the carbon material.

In the capacitor 1b, an electrolyte 13 is disposed, for example, between the first electrode 11 and the second electrode 12. In particular, the electrolyte 13 is disposed between the dielectric 20 and the second electrode 12. In the capacitor 1b, the second electrode 12 and the electrolyte 13, for example, constitute a cathode 15. In the capacitor 1b, the electrolyte 13 is disposed, for example, such that it fills the space around the porous portion of the first electrode 11.

The electrolyte 13 comprises, for example, at least one selected from the group consisting of an electrolytic solution and a conductive polymer. Examples of the conductive polymer include polypyrrole, polythiophene, polyaniline, and derivatives thereof. The electrolyte 13 may comprise a manganese compound such as manganese oxide. The electrolyte 13 may comprise a solid electrolyte.

The electrolyte 13 comprising the conductive polymer can be formed by performing chemical polymerization or electrolytical polymerization, or both chemical polymerization and electrolytical polymerization of a starting monomer(s) on the dielectric 20. The electrolyte 13 comprising the conductive polymer may be formed by attaching a solution or dispersion of the conductive polymer to the dielectric 20.

FIG. 5C is a cross-sectional view showing yet another example of a capacitor of the present disclosure. In the capacitor 1c shown in FIG. 5C, at least part of the first electrode 11 is porous. With such a feature, the first electrode 11 is likely to have a large surface area, and the capacitor 1c is likely to have a higher capacitance. Such a porous structure can be formed by a method such as etching of a metal foil or sintering of a powder.

As shown in FIG. 5C, a film of dielectric 20 is formed, for example, over the porous portion of the first electrode 11. Examples of usable methods for forming the dielectric 20 include spin coating, inkjet printing, die coating, roll coating, bar coating, the Langmuir-Blodgett method, dip coating, and spray coating. In the capacitor 1c, the dielectric 20 is disposed, for example, such that it fills the space around the porous portion of the first electrode 11.

FIG. 5D is a cross-sectional view showing yet another example of a capacitor of the present disclosure. In the capacitor 1d shown in FIG. 5D, the dielectric 20 is formed, for example, in the form of a film. Heterogeneous dielectrics 22, which differ from the dielectric 20, are dispersed or distributed in the film. Examples of usable methods for forming the film include spin coating, inkjet printing, die coating, roll coating, bar coating, the Langmuir-Blodgett method, dip coating, and spray coating. The film comprising the dielectric 20 and the heterogeneous dielectrics 22 can be obtained by forming a coating of a precursor liquid, containing a raw material for the dielectric 20 and particulate heterogeneous dielectrics 22, by the above method. The film may also be formed by sputtering, anodization, vacuum deposition, PLD, ALD, or CVD.

The heterogeneous dielectrics 22 are not particularly limited as long as they are of a type different from the dielectric 20. The heterogeneous dielectrics 22 have, for example, a higher relative dielectric constant than the dielectric 20. The heterogeneous dielectrics 22 may comprise, for example, a perovskite compound such as BaTiO₃, PbTiO₃, or SrTiO₃, or a layered perovskite compound. The heterogeneous dielectrics 22 may comprise at least one selected from the group consisting of a Ruddlesden-Popper compound, a Dion-Jacobson compound, a tungsten bronze compound, and a pyrochlore compound.

The particle size of the heterogeneous dielectrics 22 is not particularly limited. The heterogeneous dielectrics 22 have, for example, a particle size of greater than or equal to 1 nm and less than or equal to 100 nm.

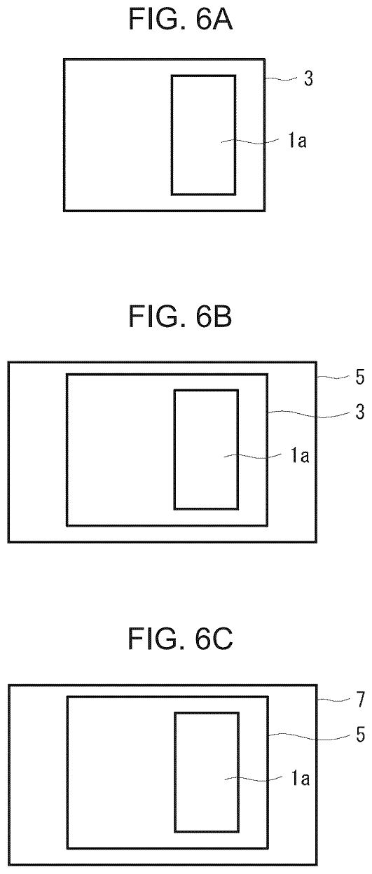

FIG. 6A is a diagram schematically showing an example of an electric circuit of the present disclosure. The electric circuit 3 includes the capacitor 1a. The electric circuit 3 may be an active circuit or a passive circuit. The electric circuit 3 may be a discharge circuit, a smoothing circuit, a decoupling circuit, or a coupling circuit. Since the electric circuit 3 includes the capacitor 1a, the electric circuit 3 is likely to deliver the desired performance. For example, the capacitor 1a is likely to reduce noise in the electric circuit 3. The electric circuit 3 may include the capacitor 1b, 1c, or 1d instead of the capacitor 1a.

FIG. 6B is a diagram schematically showing an example of a circuit board of the present disclosure. As shown in FIG. 6B, the circuit board 5 includes the capacitor 1a. The electric circuit 3 including the capacitor 1a, for example, is formed on the circuit board 5. The circuit board 5 may be an embedded board or a motherboard. The circuit board 5 may include the capacitor 1b, 1c, or 1d instead of the capacitor 1a.

FIG. 6C is a diagram schematically showing an example of a device of the present disclosure. As shown in FIG. 6C, the device 7 includes, for example, the capacitor 1a. The device 7 includes, for example, the circuit board 5 including the capacitor 1a. Since the device 7 includes the capacitor 1a, the device 7 is likely to deliver the desired performance. The device 7 may be an electronic device, a communication device, a signal processing device, or a power supply device. The device 7 may be a server, an AC adapter, an accelerator, or a flat panel display such as a liquid crystal display (LCD). The device 7 may be a USB charger, a solid state drive (SSD), an information terminal such as a PC, a smartphone, or a tablet PC, or an Ethernet switch.

### ADDITIONAL DESCRIPTION

As described hereinabove, the following technologies are disclosed herein.

### Technology 1

A halide comprising a crystal having a composition represented by ASn₂X₅, where A is a molecular cation containing at least one nitrogen atom and X is a halogen element.

### Technology 2

The halide according to Technology 1, wherein the molecular cation further contains at least one carbon atom.

### Technology 3

The halide according to Technology 1 or 2, wherein the molecular cation is an ammonium ion represented by the above formula (I), and in the formula (I), R¹, R², R³, and R⁴ are each independently a hydrogen atom, an alkyl group, an aryl group, or NH₂.

### Technology 4

The halide according to Technology 3, wherein in the formula (I), R¹ and R² are each independently a hydrogen atom, an alkyl group, or an aryl group, and R³ and R⁴ are each a hydrogen atom.

### Technology 5

The halide according to Technology 4, wherein in the formula (I), R¹, R², R³, and R⁴ are each a hydrogen atom.

### Technology 6

The halide according to Technology 3, wherein in the formula (I), R¹ is NH₂ and R², R³, and R⁴ are each a hydrogen atom.

### Technology 7

The halide according to any one of Technologies 1 to 6, wherein the halide has an anti-perovskite structure.

### Technology 8

The halide according to any one of Technologies 1 to 7, wherein the halide has a relative dielectric constant of higher than 52 at 1 MHz.

### Technology 9

A dielectric material comprising the halide according to any one of Technologies 1 to 8.

### Technology 10

A capacitor comprising:
a first electrode;
a second electrode; and
a dielectric disposed between the first electrode and the second electrode,
wherein the dielectric comprises the halide according to any one of Technologies 1 to 8.

### Technology 11

An electric circuit including the capacitor according to Technology 10.

### Technology 12

A circuit board including the capacitor according to Technology 10.

### Technology 13

A device including the capacitor according to Technology 10.

### EXAMPLES

The present disclosure will now be described in more detail with reference to examples. The following examples are provided for illustration purposes, and not intended to limit the scope of the present disclosure.

### Example 1

In a dry argon atmosphere, which was an argon atmosphere having a dew point of less than or equal to −60° C., raw material powders were prepared which consisted of NH₄Cl and SnCl₂ in amounts that satisfy the condition: amount of substance of NH₄Cl:amount of substance of SnCl₂=1:2. The raw material powders were pulverized and mixed in a mortar. In this manner, a mixed powder was obtained. The mixed powder was milled for 12 hours using a planetary ball mill under the condition of 500 revolutions per minute (rpm). In this manner, a powdered halide according to Example 1 was obtained. The halide of Example 1 had a composition represented by (NH₄)Sn₂Cl₅.

Using an X-ray photoelectron spectroscopy (XPS) apparatus PHI VersaProbe 2 manufactured by ULVAC-PHI, Inc., XPS measurement was performed on the halide of Example 1. From the results of the measurement, the contents of N, Sn, and Cl per unit weight of the halide were determined. Based on the contents of N, Sn, and Cl, and taking into account the composition of the halide, estimated from the results of the below-described XRD measurement, it was found that in the halide of Example 1, as in the raw material powders, [amount of substance of N:amount of substance of Sn:amount of substance of Cl] was approximately equal to 1:2:5.

### Evaluation of Relative Dielectric Constant

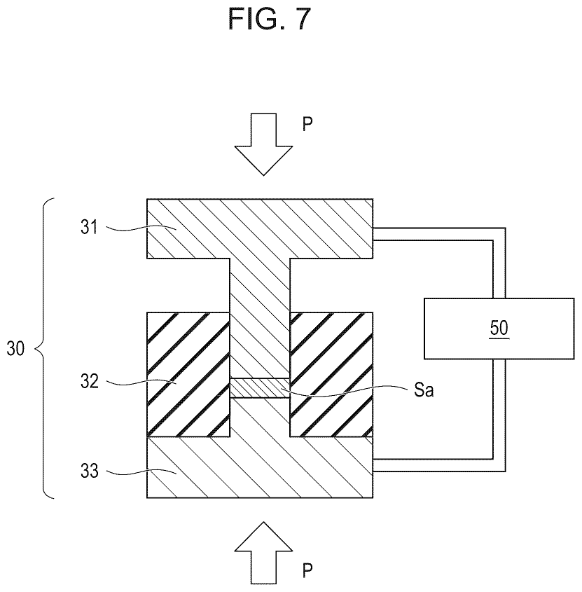

FIG. 7 is a diagram schematically showing a method for evaluating a relative dielectric constant. As shown in FIG. 7, a pressure forming die 30 includes an upper punch portion 31, a frame 32, and a lower punch portion 33. The upper punch portion 31 and the lower punch portion 33 are each made of stainless steel which is electronically conductive. The frame 32 is made of polycarbonate which is electrically insulating.

Using the pressure forming die 30, the relative dielectric constant of the halide of Example 1 was measured by the following method.

In a dry atmosphere having a dew point of less than or equal to −30° C., the powdered halide of Example 1 was filled into the pressure forming die 30 to obtain a sample Sa. A pressure P of 300 MPa was applied to the sample Sa in the pressure forming die 30 using the upper punch portion 31 and the lower punch portion 33.

While applying the pressure P to the sample Sa, the upper punch portion 31 and the lower punch portion 33 were connected to a potentiostat 50 equipped with a frequency response analyzer. VersaSTAT 4, manufactured by Princeton Applied Research, was used as the potentiostat 50. The upper punch portion 31 was connected to a working electrode and a potential measuring terminal of the potentiostat 50. The lower punch portion 33 was connected to a counter electrode and a reference electrode of the potentiostat 50. The impedance of the sample Sa was measured by an electrochemical impedance measurement method at room temperature (25° C.). In this manner, the relative dielectric constant ε′ᵣ of the halide of Example 1 at 1 MHz was measured. The capacitance of the sample Sa was measured, and the relative dielectric constant ε′ᵣ was determined based on the measured capacitance value, the thickness of the sample Sa, and the electrode area. The measured relative dielectric constant ε′ᵣ was corrected by the following equation using the filling factor f of pellet to obtain the relative dielectric constant Er. In the following equation, ε_{Air} is the relative dielectric constant of the air, and in this calculation, ε_{Air} is set to 1.

$$log {ε}_{r} = ( log {ε}_{r}^{′} - ( 1 - f ) * log {ε}_{Air} ) / f$$

The filling factor f was calculated by the following equation. ρₚₑₗₗₑₜ is the density of the pellet, and ρ is the density determined from the crystal structure. The results are shown in Table 1. As shown in Table 1, the relative dielectric constant εᵣ of the halide of Example 1, measured at 25° C., was 113.

$$f = {ρ}_{pellet} / ρ$$

### Crystal Structure Analysis

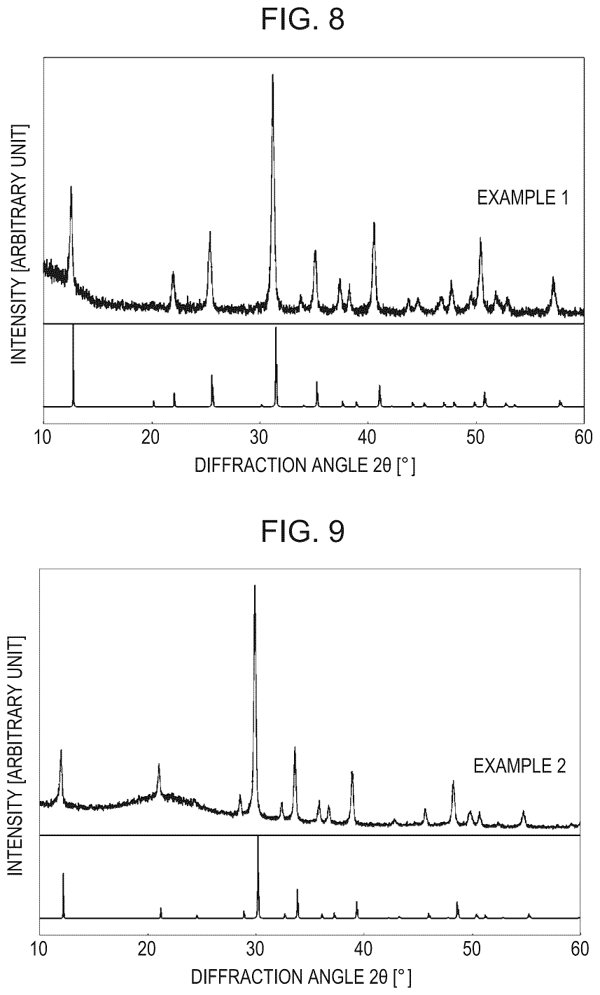

In order to identify the crystal structure of the halide of Example 1, an X-ray diffraction (XRD) measurement was performed on the halide. The measurement was performed under a dry argon atmosphere using Cu-Kα rays as X-rays. FIG. 8 is a graph showing the XRD pattern of the halide of Example 1. The abscissa axis represents the diffraction angle 20, and the ordinate axis represents the X-ray diffraction intensity. The calculation results of the XRD pattern of KSn₂Cl₅ are also shown at the bottom of FIG. 8. The ordinate axis of FIG. 8 indicates a relative relationship between diffraction intensities in each XRD pattern, and does not indicate a relative relationship between diffraction intensities in the different XRD patterns. The XRD pattern of the halide of Example 1 indicates that the halide has the same anti-perovskite crystal structure as KSn₂Cl₅.

### Example 2

A powdered halide according to Example 2 was produced in the same manner as in Example 1 except that raw material powders were prepared which consisted of NH₄Br and SnBr₂ in amounts that satisfy the condition: amount of substance of NH₄Br:amount of substance of SnBr₂=1:2. The composition of the halide of Example 2 was determined based on XRD measurement and XPS measurement as in Example 1. The crystal structure of the halide of Example 2 was determined based on XRD measurement as in Example 1. FIG. 9 is a graph showing the XRD pattern of the halide of Example 2. The calculation results of the XRD pattern of KSn₂Br₅ are also shown at the bottom of FIG. 9. The XRD pattern of the halide of Example 2 indicates that the dielectric has the same anti-perovskite crystal structure as KSn₂Br₅. The relative dielectric constant and polarization of the halide of Example 2 were evaluated in the same manner as in Example 1. The results are shown in Table 1.

### Example 3

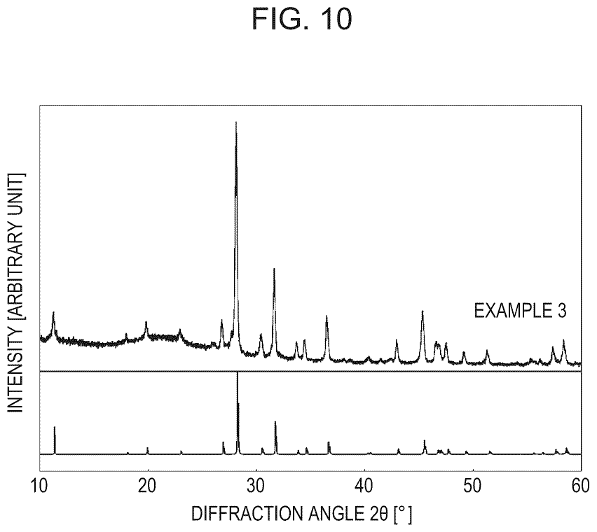

A powdered halide according to Example 3 was produced in the same manner as in Example 1 except that raw material powders were prepared which consisted of NH₄I and SnI₂ in amounts that satisfy the condition: amount of substance of NH₄I:amount of substance of SnI₂=1:2. The composition of the halide of Example 3 was determined based on XRD measurement and XPS measurement as in Example 1. The crystal structure of the halide of Example 3 was determined based on XRD measurement as in Example 1. FIG. 10 is a graph showing the XRD pattern of the halide of Example 3. The calculation results of the XRD pattern of KSn₂I₅ are also shown at the bottom of FIG. 10. The XRD pattern of the halide of Example 3 indicates that the dielectric has the same anti-perovskite crystal structure as KSn₂I₅. The relative dielectric constant and polarization of the halide of Example 3 were evaluated in the same manner as in Example 1. The results are shown in Table 1.

### Example 4

A powdered halide according to Example 4 was produced in the same manner as in Example 1 except that raw material powders were prepared which consisted of NH₂NH₃Cl and SnCl₂ in amounts that satisfy the condition: amount of substance of NH₂NH₃Cl:amount of substance of SnCl₂=1:2. The composition of the halide of Example 4 was determined based on XRD measurement and XPS measurement as in Example 1. The crystal structure of the halide of Example 4 was determined based on XRD measurement as in Example 1. The crystal structure of the halide of Example 4 was an anti-perovskite structure. The relative dielectric constant and polarization of the halide of Example 4 were evaluated in the same manner as in Example 1. The results are shown in Table 1.

### Comparative Example 1

A powdered halide according to Comparative Example 1 was produced in the same manner as in Example 1 except that raw material powders were prepared which consisted of CsCl and PbCl₂ in amounts that satisfy the condition: amount of substance of CsCl:amount of substance of PbCl₂=1:2. The composition of the halide of Comparative Example 1 was determined based on XRD measurement and XPS measurement as in Example 1. The crystal structure of the halide of Comparative Example 1 was determined based on XRD measurement as in Example 1. The crystal structure of the halide of Comparative Example 1 was an anti-perovskite structure. The relative dielectric constant and polarization of the halide of Comparative Example 1 were evaluated in the same manner as in Example 1. The results are shown in Table 1.

### Comparative Example 2

A powdered halide according to Comparative Example 2 was produced in the same manner as in Example 1 except that raw material powders were prepared which consisted of NH₄Cl and PbCl₂ in amounts that satisfy the condition: amount of substance of NH₄Cl:amount of substance of PbCl₂=1:2. The composition of the halide of Comparative Example 2 was determined based on XRD measurement and XPS measurement as in Example 1. The crystal structure of the halide of Comparative Example 2 was determined based on XRD measurement as in Example 1. The crystal structure of the halide of Comparative Example 2 was an anti-perovskite structure. The relative dielectric constant and polarization of the halide of Comparative Example 2 were evaluated in the same manner as in Example 1. The results are shown in Table 1.

### Comparative Example 3

A powdered halide according to Comparative Example 3 was produced in the same manner as in Example 1 except that raw material powders were prepared which consisted of CsCl and SnCl₂ in amounts that satisfy the condition: amount of substance of CsCl:amount of substance of SnCl₂=1:2. The composition of the halide of Comparative Example 3 was determined based on XRD measurement and XPS measurement as in Example 1. The crystal structure of the halide of Comparative Example 3 was determined based on XRD measurement as in Example 1. The crystal structure of the halide of Comparative Example 3 was an anti-perovskite structure. The relative dielectric constant and polarization of the halide of Comparative Example 3 were evaluated in the same manner as in Example 1. The results are shown in Table 1.

As shown in Table 1, the halides of Examples 1 to 4 comprise a tin ion as a metal cation, and a molecular cation containing a nitrogen atom(s). As can be appreciated by a comparison of the Examples with Comparative Example 3, in the case of a halide in which the metal cation is a tin ion, the halide is likely to have a high relative dielectric constant when it comprises a molecular cation containing a nitrogen atom(s). As can be appreciated by a comparison of the Examples with Comparative Example 2, in the case of a halide comprising a molecular cation containing a nitrogen atom(s), the relative dielectric constant of the halide is likely to be higher when the metal cation is a tin ion than when the metal cation is a lead ion. As can be appreciated by a comparison of Comparative Example 1 with Comparative Example 2, in the case of a halide comprising a lead ion as a metal cation, the presence of a molecular cation containing a nitrogen atom(s) does not increase the relative dielectric constant of the halide. Thus, it will be appreciated that the inclusion of a tin ion as a metal cation is important for the presence of a molecular cation, containing a nitrogen atom(s), to increase the relative dielectric constant of the halide.

TABLE 1

| | | | | Presence/absence | |
|---|---|---|---|---|---|
| | | | | of nitrogen- | Relative |
| | | Metal | Crystal | containing | dielectric |
| | Composition | cation | structure | molecular cation | constant εᵣ |
| Example 1 | (NH₄)Sn₂Cl₅ | Sn²⁺ | Anti-perovskite | Present | 113 |
| Example 2 | (NH₄)Sn₂Br₅ | Sn²⁺ | Anti-perovskite | Present | >300 |
| Example 3 | (NH₄)Sn₂I₅ | Sn²⁺ | Anti-perovskite | Present | >300 |
| Example 4 | (N₂H₅)Sn₂Cl₅ | Sn²⁺ | Anti-perovskite | Present | 63.6 |
| Comp. | CsPb₂Cl₅ | Pb²⁺ | Anti-perovskite | Absent | 65.3 |
| Example 1 | | | | | |
| Comp. | (NH₄)Pb₂Cl₅ | Pb²⁺ | Anti-perovskite | Present | 35.9 |
| Example 2 | | | | | |
| Comp. | CsSn₂Cl₅ | Sn²⁺ | Anti-perovskite | Absent | 51.7 |
| Example 3 | | | | | |

The halide according to the present disclosure has a high relative dielectric constant and is therefore useful.

What is claimed is:

1. A halide comprising:
a crystal having a composition represented by ASn₂X₅, where
A is a molecular cation containing at least one nitrogen atom, and
X is a halogen element.

2. The halide according to claim 1, wherein the molecular cation further contains at least one carbon atom.

3. The halide according to claim 1, wherein the molecular cation is an ammonium ion represented by the following formula: 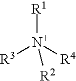
where R¹, R², R³, and R⁴ are each independently a hydrogen atom, an alkyl group, an aryl group, or NH₂.

4. The halide according to claim 3, wherein in the formula, R¹ and R² are each independently a hydrogen atom, an alkyl group, or an aryl group, and R³ and R⁴ are each a hydrogen atom.

5. The halide according to claim 4, wherein in the formula, R¹, R², R³, and R⁴ are each a hydrogen atom.

6. The halide according to claim 3, wherein in the formula, R¹ is NH₂ and R², R³, and R⁴ are each a hydrogen atom.

7. The halide according to claim 1, wherein the halide has an anti-perovskite structure.

8. The halide according to claim 1, wherein the halide has a relative dielectric constant of higher than 52 at 1 MHz.

9. A dielectric material comprising the halide according to claim 1.

10. A capacitor comprising:
a first electrode;
a second electrode; and
a dielectric disposed between the first electrode and the second electrode,
wherein the dielectric comprises the halide according to claim 1.

11. An electric circuit comprising the capacitor according to claim 10.

12. A circuit board comprising the capacitor according to claim 10.

13. A device comprising the capacitor according to claim 10.
